(19) United States
(12) Patent Application Publication
(10) Pub. No.: US 2024/0066461 A1
(43) Pub. Date: Feb. 29, 2024

(54) CARBON CAPTURE DEVICE

(71) Applicant: Welltec Manufacturing Center Completions ApS, Esbjerg N (DK)

(72) Inventor: Satish KUMAR, Esbjerg N (DK)

(21) Appl. No.: 18/457,182

(22) Filed: Aug. 28, 2023

(30) Foreign Application Priority Data
Aug. 29, 2022 (EP) 22192688.4
Jun. 2, 2023 (EP) 23177025.6

(51) Int. Cl. B01D 53/12

(52) U.S. Cl. CPC B01D 53/12; B01D 2257/504; B01D 2258/01; B01D 2259/40098

(57) ABSTRACT

A carbon capture device comprising a flue gas input, a flue gas output, a carbon adsorption zone that is in fluid communication with the flue gas input and in fluid communication with the flue gas output, where a first flue gas communication channel comprises the carbon adsorption zone, where the first flue gas communication channel comprises a first fluid input and a first fluid output, and the carbon adsorption zone comprises a first CO₂ sorbent material positioned downstream from the first fluid input and upstream to/of the first fluid output, where the first fluid input is in fluid communication with the flue gas input, and where the flue gas is directed past the CO₂ sorbent material and towards the first fluid output, where the first fluid output is in fluid communication with the flue gas output, a carbon desorption zone, where the carbon desorption zone comprises a second CO₂ sorbent material, and an actuation device where the actuation device is configured to transport carbon-rich first CO₂ sorbent material from the carbon adsorption zone to the carbon desorption zone and to transport carbon-lean second CO₂ sorbent material from the carbon desorption zone to the carbon adsorption zone.

### TECHNICAL FIELD

A carbon capture device comprising a flue gas input, a flue gas output, a carbon adsorption zone that is in fluid communication with the flue gas input and in fluid communication with the flue gas output, where a first flue gas communication channel comprises the carbon adsorption zone, where the first flue gas communication channel comprises a first fluid input and a first fluid output, and the carbon adsorption zone comprises a first CO₂ sorbent material positioned downstream from the first fluid input and upstream to the first fluid output.

### DESCRIPTION

The issue of climate change has become a topic driving the directions of almost every business operation. Various climate change mitigation solutions have been proposed for various sectors and are at various stages of maturity. The road transport sector is said to account for around 11.9% of global GHGs (Climate Watch, World Resources Institute 2020). Lithium batteries, hydrogen, ammonia, and methanol have been the mitigation pathways in this sector, with lithium batteries by far leading the competition. While the use of lithium batteries has picked up in terms of acceptance level for light motor vehicles, heavy-duty transport has still been largely unaffected, as the weight of the batteries is significant, and the amount/magnitude of lithium needed to equip the heavy vehicle transport sector is massive. One mitigation solution for heavy transport involves addressing the issue by capturing the CO₂ directly from the air (DAC) or from various industrial sources to recycle it to form synthetic fuels. This method is largely called CCU, or Carbon Capture and Utilization. While these methods have been proposed mostly for industrial emissions, the intention of this project is to develop a commercial retrofittable in-situ carbon capture, transport and re-use (ICCTR) system for the heavy-duty road transport sector that could also be used for light-weight motor vehicles. This solution could minimize the need to develop new distribution infrastructure while transitioning the road transport sector to become carbon neutral without the need for major modifications to their engines. This method would also reduce the dependency of the synthetic fuel cycle on direct air capture methods, assuring a reliable feedstock of CO₂ and thus enabling a carbon neutral and sustainable energy system. The elimination of batteries in heavy transport could also help the heavy transport sector remain independent of the underlying geopolitics associated with batteries.

Thus, there is a need to attempt to reduce the CO₂ emissions from the heavy-duty transport sector, and especially in the area of heavy-duty transport vehicles, such as long-haul trucks having internal combustion engines.

In accordance with the invention, there is provided a carbon capture device comprising a flue gas input, a flue gas output, a carbon adsorption zone that is in fluid communication with the flue gas input and in fluid communication with the flue gas output, where a first flue gas communication channel comprises the carbon adsorption zone, where the first flue gas communication channel comprises a first fluid input and a first fluid output, and the carbon adsorption zone comprises a first CO₂ sorbent material positioned downstream from the first fluid input and upstream to/of the first fluid output, where the first fluid input is in fluid communication with the flue gas input, and where the flue gas is directed past the CO₂ sorbent material and towards the first fluid output, where the first fluid output is in fluid communication with the flue gas output, a carbon desorption zone, where the carbon desorption zone comprises a second CO₂ sorbent material, and an actuation device where the actuation device is configured to transport carbon-rich first CO₂ sorbent material from the carbon adsorption zone to the carbon desorption zone and to transport carbon-lean second CO₂ sorbent material from the carbon desorption zone to the carbon adsorption zone.

This means that a carbon capture device may be provided where the CO₂ sorbent material may be transported from the carbon adsorption zone and the carbon desorption zone continuously using an actuator, where carbon-rich CO₂ sorbent material, which has been saturated with the carbon of the flue gas in the carbon adsorption zone, may be transported away from the adsorption zone and towards the carbon desorption zone. Thus, by moving the carbon-rich CO₂ sorbent material to the desorption zone, the CO₂ may be desorbed from the CO₂ sorbent material and may be collected or trapped when the CO₂ is released from the CO₂ sorbent material, thereby preventing a large part of the CO₂ from entering the atmosphere. While this is happening, a second CO 2 sorbent material may be moved from the carbon desorption zone, where the second CO₂ sorbent material is carbon-lean, i.e. where the CO₂ that can be adsorbed by the material has been released, and the carbon-lean CO₂ sorbent material may be transported back to the carbon adsorption zone, where the carbon-lean CO₂ sorbent material is in a state where the material can adsorb CO₂ gasses from the flue gas. The sorbent material may be of any solid form, such as powder, granules, pellets, extruded forms, fibres, etc.

This operation is different from what is known in the art in that the art discloses the use of reactor units that are interconnected via flow circuits and valves and may be operated to successively cycle the reactor units through different states from adsorption, preheating, desorption and precooling. Thus, the reactors are provided with CO₂ sorbent material, where the operation of each reactor may be changed from one state to another state. Thus, the CO₂ sorbent material that is introduced into one reactor is maintained inside the reactor, where the state of the adsorbent material determines what state the reactor is put into. Thus, when a CO₂ sorbent material in a first reactor has adsorbed a predefined amount of CO₂, the state of the reactor is changed to a preheating state where the CO₂ sorbent material is prepared for desorption, and when the CO₂ sorbent material has been heated, the state of the reactor is changed to a desorption state. Thus, the CO₂ sorbent material is kept inside one reactor and is never transported from one reactor to another reactor or from one zone of the reactor to another zone.

However, the carbon capture device of the present invention has predefined areas having predefined purposes or states, where it is the CO₂ sorbent material that is transported between zones of the carbon capture device. Doing so makes the adsorption system less bulky, and may use a reduced amount of adsorption material and may be more inexpensive to construct.

The flue gas input may be in fluid communication with a first fluid input, where the first fluid input may be in fluid communication with the carbon adsorption zone via the first flue gas communication channel. When the flue gas has passed through the carbon adsorption zone, the flue gas, which may be have a reduced CO₂ content, will exit the carbon adsorption zone via the first fluid output, which is in fluid communication with the flue gas output. The CO₂ sorbent material may be positioned inside the carbon adsorption zone, where the CO₂ sorbent material enters the carbon adsorption zone in a carbon-lean state, and where the CO₂ sorbent material is in a state where the CO₂ sorbent material is capable of adsorbing the CO₂ from the flue gas when the flue gas enters the carbon adsorption zone. The flow rate of the adsorbent in the actuation system may be determined such that when the CO₂ sorbent material has adsorbed sufficient (a predetermined amount) of CO₂, the material may be transported via an actuator towards the carbon desorption zone of the device. The flow rate may be varied electronically by means of a closed loop feedback system where several parameters of the engine and the adsorption system are measured, ensuring optimal functioning of the entire system. Thus, the transport of the carbon-rich CO₂ sorbent material is initiated when sufficient CO₂ has been adsorbed by the material, and the material is transported to the carbon desorption zone, where the CO₂ is desorbed (released from the CO₂ sorbent material) and can be collected from the carbon desorption zone. When sufficient carbon has been released from the CO₂ sorbent material in the carbon desorption zone, the carbon-lean CO₂ sorbent material may be transported back to the carbon adsorption zone of the device via an actuator. This initiation may be done by using sensors, or may be determined using test methods, where the CO₂ gasses in the flue gas output may be monitored, and the transport rate of the sorbent material in the system may be determined.

Thus, the present device provides a cycle of CO₂ sorbent material where the positioning of the CO₂ sorbent material in predetermined parts of the device determines the state and/or operation of the CO₂ sorbent material in order to provide carbon capture from a flue gas. The CO₂ sorbent material may be cycled from one position to a second position in the device, and from a second position to a third position in the device, where the CO₂ sorbent material is eventually cycled back to its first position. The cycle may be repeated continuously to move the CO₂ sorbent material throughout different positions in the device, where each position may have a different purpose, such as adsorption, desorption, heating and/or cooling.

Within the understanding of the present invention, the first CO₂ sorbent material and the second CO₂ sorbent material may be the same or similar material, and the first CO₂ sorbent material and the second CO₂ sorbent material may be part of a total amount of CO₂ sorbent material present in the carbon capture device. The use of the terminology “first” and “second” should be considered as an identifier for the CO₂ sorbent material in different positions inside the carbon capture device.

In one exemplary embodiment of the present disclosure, the device may comprise a thermal management system that maintains the desorption zone at a desorption temperature Td and the adsorption zone at a temperature Ta. The desorption temperature may be the second temperature and the first temperature may be the first temperature.

In one exemplary embodiment of the present invention, the carbon-lean material may be stacked on top of the carbon-richer material in the carbon adsorption zone, and the carbon-rich material may be positioned at the bottom of the carbon adsorption zone. Thus, when the carbon-lean material is introduced into the carbon adsorption zone of the device, the carbon-lean material may be arranged on top of the CO₂ sorbent material that is already positioned inside the carbon adsorption zone. Thus, the carbon-lean material (second CO₂ sorbent material) may be introduced into the carbon adsorption zone via gravity.

In accordance with one or more exemplary embodiments, CO₂ sorbent materials (adsorbent materials) may include metal organic frameworks (Mg, Zn, Al or Fe MOF), zeolitic imidazolate frameworks (ZIF-8, ZIF-69), amine functionalized porous polymer networks (PPN-6-CH2-DETA, PPN-6-CH2-TETA), amine infused silica (PEI-silica), amine loaded MCM-41 (PEI-MCM-41), mmen-M2(dobpdc) frameworks, zeolites (Zeolite-5 A), or any MOFs and zeolite that is capable of adsorbing CO₂ as disclosed in the present disclosure. In an embodiment, amine-doped metal-organic framework (MOF) adsorbents are selected for CO₂ capture, as they show good performance in the presence of water.

In accordance with one or more exemplary embodiments, CO₂ sorbent materials (adsorbent materials) may include a liquid comprising a porous solid, where the liquid may be selected from a deep eutectic solvent, a liquid oligomer, a bulky liquid, a liquid polymer, a silicone oil, a halogenated oil, a paraffin oil, a triglyceride oil or a combination thereof. The porous solid may be selected from a MOF, a zeolite, a covalent organic framework (COF), a porous inorganic material, a Mobil Composition of Matter (MCM) or a porous carbon. Porous solids can be microporous, in which a major part of the porosity results from pores with widths of less than 2 nm, or mesoporous, in which a major part of the porosity results from pores with widths between −2 nm and 50 nm. Examples of such porous liquid may be found in U.S. Pat. No. 11,565,212 and may be included by reference in the present disclosure.

In accordance with one or more exemplary embodiments, CO₂ sorbent materials (adsorbent materials) may include a dispersion comprising porous particles dispersed in a liquid phase, wherein the porous particles comprise a zeolite and the liquid phase is a size excluded liquid. The porous particles may be microparticles and/or nanoparticles. More particularly, the porous particles may be microparticles. Microparticles are generally defined as particles having a mean diameter in the range 0.1-100 μm 35 (ie 100-100,000 nm). More particularly, the porous particles may have a mean diameter in the range 0.1-2 μm (ie 100-2000 nm). Nanoparticles are generally defined as particles having a mean diameter in the range 1-100 nm. Examples of such dispersions may be found in U.S. Pat. No. 11,571,656 and may be included by reference in the present disclosure.

In one exemplary embodiment, the device may comprise a heat exchanger that may be configured to extract heat energy from the flue gas upstream from the flue gas input, and optionally provide thermal energy to the CO₂ sorbent material to increase or decrease the temperature of the CO₂ sorbent material inside the system. The CO₂ sorbent material may be a material that is capable of performing different tasks at different temperatures, where the CO₂ sorbent material may be configured to adsorb CO₂ at a first temperature and may be configured to desorb CO₂ at a second temperature. The sorbent material and the method to use it may be Thermal Swing Adsorption (TSA). The heat exchanger may be utilized to harvest heat energy from the flue gas, where the heat exchanger may e.g. reduce the heat of the flue gas before it enters the first fluid input, and where the absorbed heat from the flue gas may be utilized to increase the temperature of the CO₂ sorbent material after the material has been transported from the carbon adsorption zone towards the desorption zone. The thermal energy absorbed from the flue gas can also be utilized for different purposes, such as heating up different zones of the carbon capture device, where the CO₂ sorbent material absorbs the heat when passing a heated zone of the carbon capture device.

The temperature of the flue gas may be in the range from 350 to 700° C., where the heat exchanger may be capable of absorbing heat energy and may provide a flue gas into the flue gas input that may be between 25-40° C. The carbon adsorption zone may have a temperature that is between 25-40° C., which is similar to the temperature of the flue gas. The CO₂ adsorption material may be configured to adsorb CO₂ at 25-40° C. from the flue gas stream. In another embodiment, the temperature range may vary from 25-50° C. or 25-70° C.

In one exemplary embodiment, the carbon capture device may comprise a condenser that is in fluid communication with the flue gas, where the condenser is positioned upstream to/of the carbon adsorption zone. The condenser may be utilized to remove at least a part of moisture that may be present in the flue gas so that when the flue gas enters the carbon adsorption zone, the condenser has reduced the moisture content of the flue gas.

In one exemplary embodiment, the carbon capture device may comprise a heat exchanger configured to transfer thermal energy from the flue gas to a first cooling fluid. The cooling fluid may be utilized to transport the thermal energy from the heat exchanger to a heating zone, where the thermal energy from the cooling fluid is introduced into the carbon-rich CO₂ adsorption material before the material enters the carbon desorption zone.

In one exemplary embodiment, the first and/or the second CO₂ sorbent material may be heated from a first temperature to a second temperature in a first transition zone between the carbon adsorption zone and the carbon desorption zone. The temperature of the carbon-rich CO₂ adsorption material may be increased from a first temperature (25-40° C.) to a second temperature (120-150° C.), where the increase in temperature will cause the adsorbed CO₂ to be extracted from the CO₂ adsorption material. Thus, the CO₂ adsorption material may be heated from an adsorption temperature to a desorption temperature using the thermal energy extracted from the flue gas. Furthermore, the cooling fluid may be in connection with a cooling fan or a radiator, where excess thermal energy may be released, and where the thermal energy of the cooling fluid may be extracted in order to reuse the absorbed thermal energy from the flue gas and the heat exchanger.

In one exemplary embodiment, the first and/or the second CO₂ sorbent material may be cooled from a second temperature to a first temperature in a second transition zone between the carbon desorption zone and the carbon adsorption zone. The cooling fluid may be fed from the cooling fan/radiator to cool the CO₂ adsorption material during transport from the carbon adsorption zone to the carbon desorption zone in order to prepare the CO₂ adsorption material for being at a temperature where the CO₂ adsorption material is configured to adsorb the CO₂ from the flue gas. Thus, the CO₂ adsorption material may be cooled from the second temperature (120-150° C.) to a first temperature 25-40° C.) where the decrease in temperature will cause the CO₂ adsorption material to be capable of adsorbing CO₂ from the flue gas when the CO₂ adsorption material enters the carbon adsorption zone.

In one exemplary embodiment, the actuation device may be in the form of a screw (auger) conveyor device. The screw conveyor device may be configured to mechanically transport the first (carbon-rich) CO₂ adsorption material from the carbon adsorption zone, where the screw conveyor device may have a first conveyor input, and where the material is transported via rotational actuation of the screw conveyor from the carbon adsorption zone, and where the screw conveyor may have a first conveyor output, where the CO₂ adsorption material is introduced into the carbon desorption zone. In the same manner, the screw conveyor, or a second screw conveyor having a second conveyor input, may transport the second (carbon-lean) CO₂ adsorption material from the carbon desorption zone, and where the material is transported via rotational actuation of the screw conveyor from the carbon desorption zone, and where the screw conveyor may have a second conveyor output, where the carbon-lean CO₂ adsorption material is introduced into the carbon adsorption zone and replaces the carbon-rich CO₂ adsorption material that exits the carbon adsorption zone.

In one exemplary embodiment, the carbon capture device may comprise a closed loop system where the carbon adsorption zone may be in fluid communication with the carbon desorption zone, and/or where the carbon desorption zone may be in fluid communication with the carbon adsorption zone. The closed loop system may be a closed loop system when viewing the CO₂ adsorption material, which means that the CO₂ adsorption material is cycled from one zone to another zone and onwards to the next zone until it returns to the original zone, and the closed loop system ensures that the CO₂ adsorption material is continuously cycled through the closed loop system.

In one exemplary embodiment, the carbon capture device may comprise a closed circulating structure configured to receive the carbon adsorption material, and where the closed circulating structure may comprise the carbon adsorption zone, the carbon desorption zone and/or the actuation device. The closed circulation structure may ensure that the CO₂ adsorption material is circulated around the carbon capture device, where the CO₂ adsorption material is moved around the device relative to the carbon adsorption zone, the carbon desorption zone and/or the actuation device. The circulating structure may also comprise a heating zone and a cooling zone, where the temperature of the CO₂ adsorption material may be increased or decreased, respectively, before the CO₂ adsorption material enters the carbon desorption zone or the carbon adsorption zone, respectively. Consequently, the adsorption material is designed to be able to withstand several thermal cycles while maintaining its structural integrity.

In one exemplary embodiment, the carbon adsorption zone may be arranged in a first tubular body, and the carbon desorption zone may be arranged in a second tubular body. The first tubular body and the second tubular body may have a CO₂ adsorption material input and a CO₂ adsorption material output, where the CO₂ adsorption material is introduced via the input and removed from the tubular body via the output. In the area between the input and the output, the tubular body may comprise a holding zone, where the adsorption or the desorption may occur primarily in the holding zone of the CO₂ adsorption material. The actuator device may be connected to the CO₂ adsorption material output, where the actuator device mechanically moves the CO₂ adsorption material from the CO₂ adsorption material output of the first and/or the second tubular body and moves it towards the CO₂ adsorption material input in the second and/or the first tubular body. Thus, it is possible to transport the CO₂ adsorption material from one tubular body to another tubular body, where the tubular bodies may be arranged to allow the CO₂ adsorption material to adsorb CO₂ from the flue gas or to desorb CO₂ from the CO₂ adsorption material inside the second tubular body.

In one exemplary embodiment, the carbon adsorption zone and/or the carbon desorption zone may be in the form of a fluidized bed. The CO₂ adsorbent material may be in the form of particles forming a fluidized bed, where the carbon adsorption zone and/or the carbon desorption zone may be provided with CO₂ adsorption material particles in a fluidized bed. The actuator device may be configured to transport the particles in the form of a fluidized bed, or may also transport the particles as a solid particulate substance, where the carbon adsorption zone and the carbon desorption zone provide the particulate material in the form of a fluidized bed.

In one exemplary embodiment, the carbon capture device may be a Thermal Swing Adsorption (TSA) CO₂ capture system. An advantageous contribution of the project might be a compact hybrid moving fluidized bed concept. It combines the advantages of a fluidized bed powder adsorbent system and a feed-screw-based powder transport system to build a compact loop where the adsorbent powder is processed through a temperature swing and recycled continuously in a compact form factor. To make the system efficient, the system could be designed with a minimal number of active components, such as pumps and heating/cooling systems, to reduce the overall cost. Inherent heat from the engine and flue gases will be reused to minimize the fuel consumption of the combustion engine.

In one exemplary embodiment, the carbon desorption zone may be in fluid communication with a CO₂ output, where the CO₂ output may optionally be in communication with a pump (or a compressor) and a CO₂ storage tank. Thus, when the carbon is desorbed from the carbon-rich CO₂ adsorption material in the carbon desorption zone, the CO₂ may exit the carbon desorption zone via the CO₂ output and may be pumped from the output into a storage tank, where the storage tank is capable of storing the CO₂ that has been removed from the flue gas. The CO₂ storage tank may be a pressurized tank with adsorbents to reduce storage pressure or without adsorbents. The tank may be fitted with a quick connect pressure connection to remove the stored CO₂ or the tank is detachably connected to the system to swap the tank with an empty tank when necessary.

In one exemplary embodiment, the CO₂ output may be in fluid communication with a CO₂ storage, where the CO₂ storage may be in the form of dry ice slurry or CO₂ in solid form, such as blocks of CO₂, or the CO₂ may be in liquid or supercritical form. The CO₂ storage may be kept at a pressure and a temperature that allow the CO₂ to be in a particular form. As an example, if the CO₂ is to be stored in solid form (dry ice), the pressure of the CO₂ storage may be between 0-5.18 bar and have a temperature below −56.6° C. The person skilled in the art may refer to a carbon dioxide phase diagram to find the correct temperature and pressure to obtain the desired phase of the CO₂ for the desired state of CO₂ during storage.

In one exemplary embodiment, the carbon capture device may be a carbon capture device for an internal combustion engine. The present system may be configured to receive flue gas from an internal combustion engine, where the flue gas of the internal combustion engine has an amount of CO₂ which may be captured by the carbon capture device. The device is of a size where the device may be applied to a vehicle such as a transport truck or an automobile, or alternatively to any kind of vehicle that has an internal combustion engine. Alternatively, or additionally the carbon capture device may be applied to a marine vessel, having an internal combustion engine. The continuous cycle of the CO₂ adsorption material in the system ensures that the CO₂ adsorption material may continuously be reused by loading and unloading the CO₂ adsorption material with CO₂, and where heat from the flue gas may be utilized to heat up the CO₂ adsorption material to transform the CO₂ adsorption material from an adsorption state to a desorption state.

A vehicle may be seen as a piece of equipment designed to transport people or cargo. Vehicles may include wagons, bicycles, motor vehicles (motorcycles, cars, trucks, buses, mobility scooters for disabled people), railed vehicles (trains, trams), watercraft (ships, boats, underwater vehicles), amphibious vehicles (screw-propelled vehicles, hovercraft), aircraft (airplanes, helicopters, aerostats) and spacecraft.

In one exemplary embodiment, the first CO₂ sorbent material and/or the second CO₂ sorbent material may be in the form of pellets, powder, a granular substance, a grainy substance, or particulates.

In one exemplary embodiment the carbon capture device may comprise an electronic controller and sensors for measuring various parameters of the engine and the CO₂ capture system to adjust the speed of sorbent transfer in the system, temperatures, or other variables relating to carbon capture.

In one embodiment, the carbon capture device may comprise a second cooling assembly, where the second cooling assembly provides a stream of cooling fluid to the adsorbent material and/or the carbon adsorption zone at a second temperature that is lower than the ambient temperature of the carbon capture system.

In one embodiment, the second temperature is below 0° C., more specifically between 0° C. and −80° C., even more specifically between −10° C. and −60° C., or even more specifically between −40° C. and −50° C.

In one embodiment, the secondary cooling assembly may comprise an air compressor, a heat exchanger and an expander.

In one embodiment, the expander may be an expander turbine driven by excess heat from an internal combustion engine and/or from a vehicle.

The present disclosure also relates to a carbon capture system for flue gas, the system comprising an internal combustion engine of a vehicle and a carbon capture device.

The present disclosure may relate to an industrial plant having one or more sources for flue gas, the industrial plant comprising a carbon capture device, comprising: a flue gas input, a flue gas output, a carbon adsorption zone that is in fluid communication with the flue gas input and in fluid communication with the flue gas output, where a first flue gas communication channel comprises the carbon adsorption zone, where the first flue gas communication channel comprises a first fluid input and a first fluid output, and the carbon adsorption zone comprises a first CO₂ sorbent material positioned downstream from the first fluid input and upstream to/of the first fluid output, where the first fluid input is in fluid communication with the flue gas input, and where the flue gas is directed past the CO₂ sorbent material and towards the first fluid output, where the first fluid output is in fluid communication with the flue gas output, a carbon desorption zone, where the carbon desorption zone comprises a second CO₂ sorbent material, and an actuation device, where the actuation device is configured to transport carbon-rich first CO₂ sorbent material from the carbon adsorption zone to the carbon desorption zone and to transport carbon-lean second CO₂ sorbent material from the carbon desorption zone to the carbon adsorption zone.

Within the context of the present disclosure an industrial plant may be a power plant, a manufacturing plant, a production plant, an incarnation plant, or any other type of industrial facility that may have a flue gas or exhaust gas release which has a CO₂ content, or any type of CO₂ emission devices, such as a flue, pipe or channel for channelling exhaust gasses.

Alternatively, the industrial plant may be in the form of a biogas plant, which may treat farm waste or energy crops to use e.g. micro-organisms to transform biomass waste into biogas, such as methane. During production of biogas, there is a biproduct in the form of CO₂, where the carbon capture device may be utilized to capture part of the CO₂ that is produced during the biogas production.

The industrial plant may be in the form of a Hydrogen producing facility, where CO₂ may be a biproduct of an H2 production process, where the carbon capture device may be utilized to capture CO₂ particles that are in an output fluid and/or gas of a H2 production facility.

Furthermore, the industrial plant may have a biogas burner, where the exhaust of the biogas burner may be fed into a carbon capture device in accordance with the present disclosure, where the carbon capture device may capture at least part of the CO₂ of the exhaust gasses.

The following is an explanation of exemplary embodiments with reference to the drawings, in which:

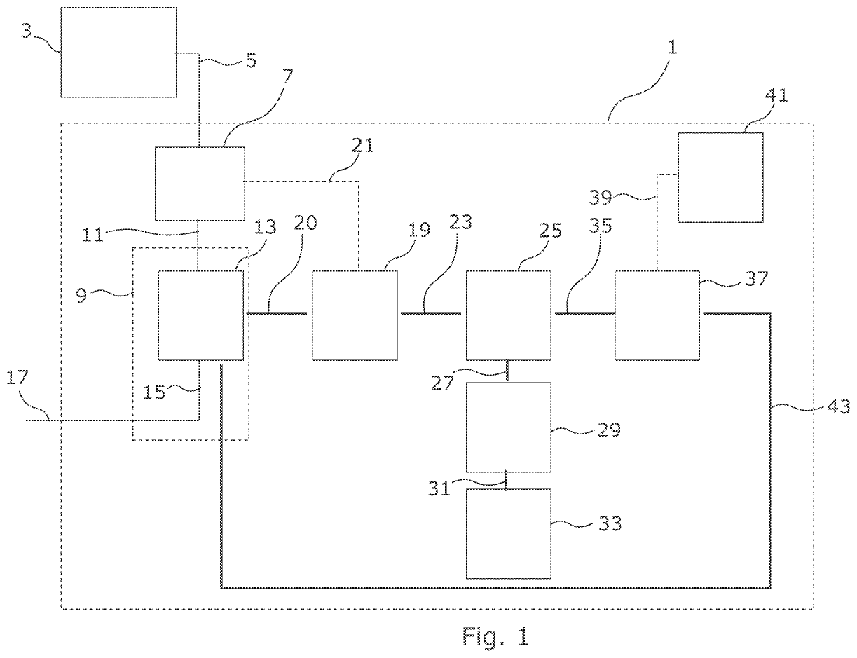

FIG. 1 shows a process diagram of a carbon capture system in accordance with the present disclosure,

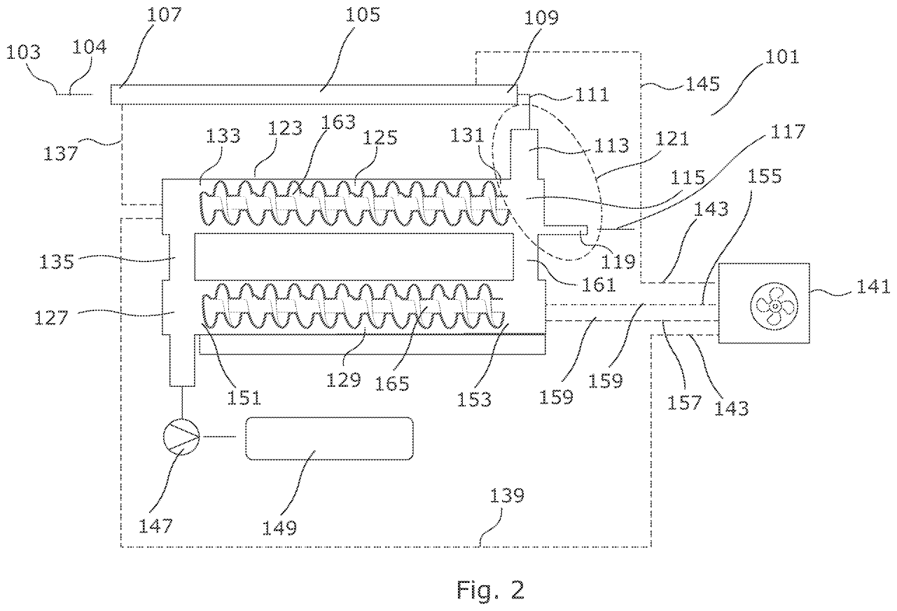

FIG. 2 is a schematic view of an embodiment of a carbon capture system in accordance with the present disclosure,

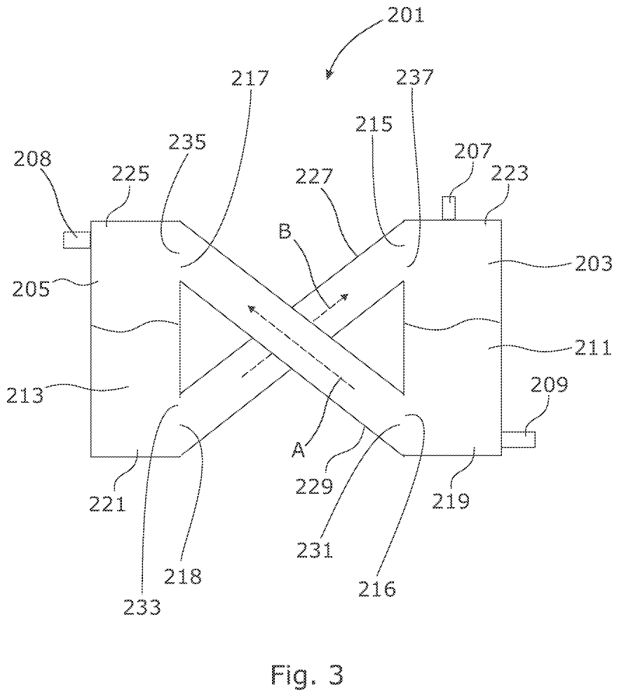

FIG. 3 is a schematic view of an embodiment of a carbon capture system in accordance with the present disclosure,

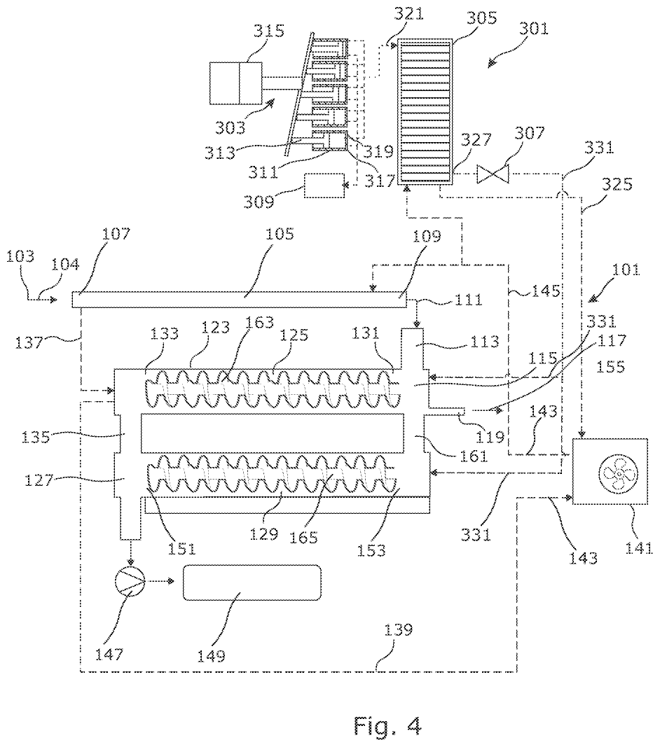

FIG. 4 is a schematic view of an embodiment of a carbon capture system in accordance with the present disclosure,

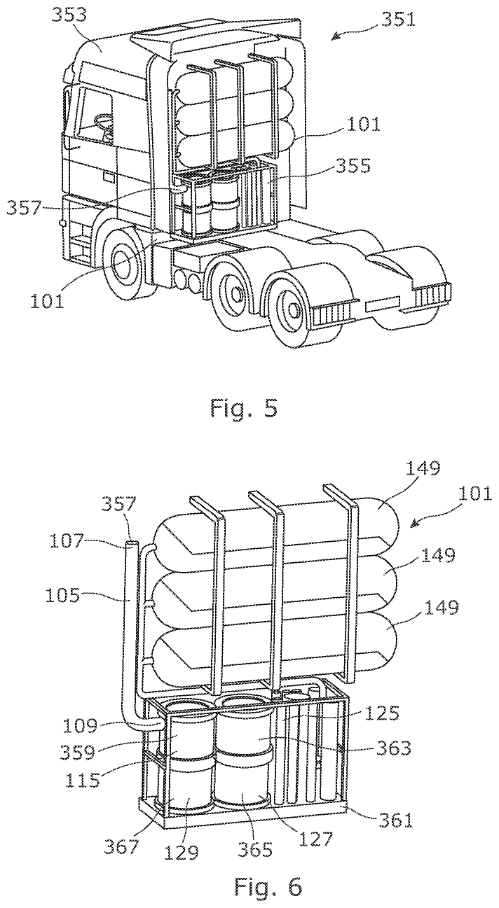

FIG. 5 is a perspective view of a vehicle having a carbon capture system in accordance with the present disclosure,

FIG. 6 is a perspective view of a carbon capture system in accordance with the present disclosure,

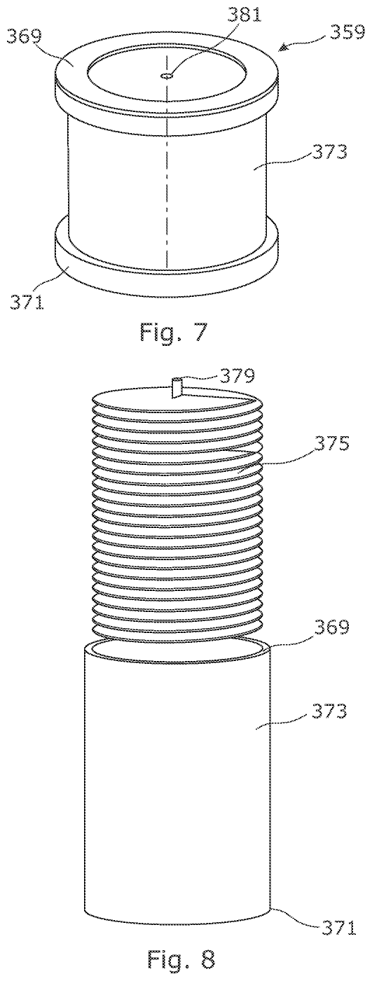

FIG. 7 is a perspective view of a portion of a carbon capture system in accordance with the present disclosure,

FIG. 8 is an exploded view of the portion shown in FIG. 7, and

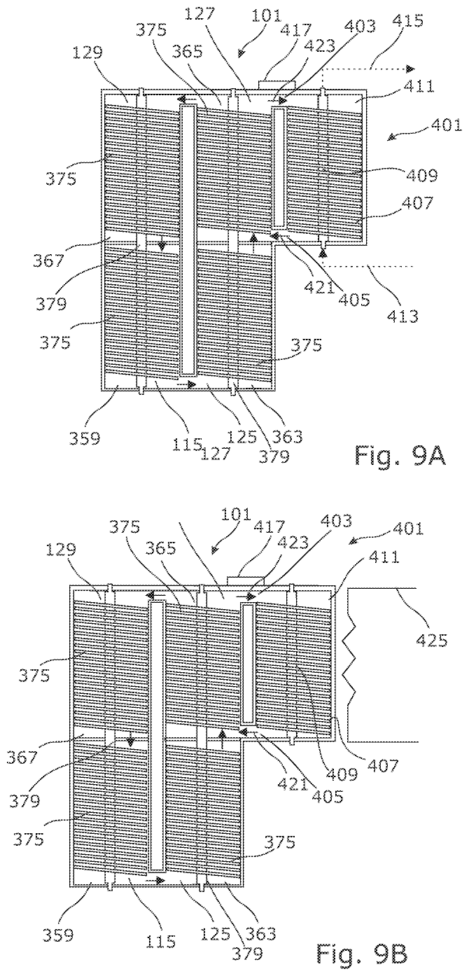

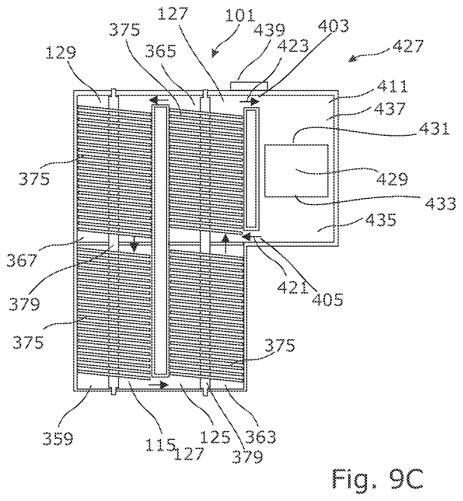

FIGS. 9A-9C show a schematic view of a carbon capture system having a secondary heating device.

### DETAILED DESCRIPTION

Various exemplary embodiments and details are described hereinafter, with reference to the figures when relevant. It should be noted that the figures may or may not be drawn to scale, and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practised in any other embodiments even if not so illustrated, or if not so explicitly described.

FIG. 1 shows a process diagram of an embodiment of a carbon capture system 1, where the carbon capture system 1 is in connection with an internal combustion engine 3. When the internal combustion engine 3 is operated and run, the engine 3 produces exhaust gasses, which may be in the form of flue gas, where the flue gas may be directed via fluid communication 5 to the carbon capture system 1. The fluid communication 5 may connect the internal combustion engine 3 with a heat exchanger 7 of the system 1, where the heat exchanger may be utilized to cool the flue gas (exhaust gasses) from a first temperature to a second temperature.

The heat exchanger 7 is in fluid communication with a first flue gas communication channel 9, where the first flue gas communication channel 9 comprises a first fluid input which receives the cooled flue gas 11 from the heat exchanger. The first flue gas communication channel 9 comprises a carbon adsorption zone 13, where the CO₂ from the flue gas may be adsorbed by a CO₂ sorbent material. The flue gas communication channel may further comprise a first outlet 15, where the flue gas may be released from the flue gas communication channel when CO₂ has been adsorbed from the flue gas, and where the first outlet is connected to a flue gas output which releases the flue gas from the device 1. An example of the composition of flue gas of an internal combustion engine may be N2:67%, 02:9%, CO₂: 12%, H₂O 11%, CO+HC+NOx+SO2+PM:1%.

When the CO₂ from the flue gas has been adsorbed by the CO₂ sorbent material, the CO₂ sorbent material is carbon-rich and is transported towards a carbon desorption zone 25, where the transport from the carbon adsorption zone 13 is performed using an actuator 19 in a direction 20 away from the carbon adsorption zone 13. While the CO₂ sorbent material is being transported from the carbon adsorption zone 13, the CO₂ sorbent material may be heated up from a first temperature to a second temperature, where a thermal energy 21 from the heat exchanger 7 may be utilized to warm up the CO₂ sorbent material in order to transform the state of the CO₂ sorbent material from being capable of receiving CO₂ to a state where the CO₂ sorbent material releases CO₂. The actuator transports the carbon-rich material in a direction 23 towards a carbon desorption zone 25, and where the CO₂ sorbent material has been heated up to a second temperature. In the carbon desorption zone 25 the carbon is released from the CO₂ sorbent material, where the CO₂ may be fed via fluid connection 27 to a pump 29 which pumps the CO₂ via a fluid connection 31 to a storage tank 33, and where the storage tank can collect the CO₂ that is captured from the flue gas.

At the desorption zone where the CO₂ sorbent material has been depleted of CO₂ (or has reached a certain level of CO₂), the CO₂ sorbent material is transported in a direction 35 via an actuation device 37, where the actuation device 37 transports the carbon-lean CO₂ sorbent material in a direction 43 back to the carbon adsorption zone 13. During the transport by the actuation device 37, the CO₂ sorbent material may be cooled from a second temperature and back to a first temperature, using cooling 39 received from a cooling device 41, such as a radiator. Thus, the reduction in temperature ensures that the CO₂ sorbent material is in a state where the CO₂ sorbent material can receive CO₂ from the flue gas.

Thus, a carbon capture device is provided where the CO₂ sorbent material is cycled through different zones in the device to alternatively adsorb CO₂ from a flue gas, or alternatively to desorb CO₂ to a storage.

Storage tank 33 could be a detachable unit of the system that when filled with CO 2 to a certain predetermined value, could be swapped over with an empty tank.

Alternatively, the tank could be fitted with a pressure tight quick connect to empty the stored CO₂ into another tank.

FIG. 2 shows a schematic diagram of a carbon capture device 101 in accordance with the present disclosure, where the carbon capture device comprises a flue gas input 103, where hot flue gas 104 is received from an internal combustion engine. The flue gas input 103 is fed into a heat exchanger 105 having an exchanger input 107 and an exchanger output 109, where the flue gas may enter the exchanger input 107 at a third temperature of between 350-700° C. During the transition from the exchanger input 107 and the exchanger output 109, the temperature of the flue gas will be reduced to a first temperature of about 25-40° C., where the flue gas has a temperature that is suited for the carbon capture device. Cold flue gas 111 is communicated to a first fluid input 113, where the flue gas enters a carbon adsorption zone 115, and where CO₂ is removed from the flue gas, creating a carbon-lean flue gas. Carbon-lean flue gas 117 exits the carbon adsorption zone 115 via a first fluid outlet 119, where the first fluid outlet is in fluid communication with a flue gas outlet (not shown). The first fluid input 113, the carbon adsorption zone 115 and the first fluid outlet 119 may be part of a flue gas communication channel 121 which isolates the flue gas from the rest of the device, or at least the parts of the device that holds a CO₂ adsorption material.

The carbon adsorption zone 115 comprises a CO₂ adsorption material where the carbon adsorption material in the carbon adsorption zone is configured to adsorb CO₂ from the flue gas 111, and remove CO₂ from the flue gas 111 to create the carbon-lean flue gas 117 that may exit the carbon adsorption zone 115.

The carbon capture device 101 comprises a closed loop 123 holding a CO₂ adsorption material, where the closed loop comprises the carbon adsorption zone 115, a first transition zone 125, a carbon desorption zone 127 and a second transition zone 129, where these zones comprise a CO₂ adsorption material in different states, depending on the CO₂ adsorption material capability of adsorbing or desorbing CO₂, or during a transitional period where the CO₂ adsorption material is transformed from an adsorption state to a desorption state, or vice versa. The CO₂ adsorption material is in an adsorption state in the carbon adsorption zone 115, and is in a desorption state in the carbon desorption zone 127. However, in the first transition zone 125 the CO₂ adsorption material is heated up from a first temperature of 25-40° C. in a first end 131 of the first transition zone 125 to a second temperature of between 120-150° C. in a second end 133 of the transition zone, where the second temperature is suited for carbon desorption in the carbon desorption zone 127. The thermal energy utilized to heat up the CO₂ adsorption material from its first temperature to the second temperature may be harvested from the heat exchanger 105, via e.g. a first cooling/heating fluid 137. When the thermal energy has been absorbed by the CO₂ adsorption material in the first transition zone 125, a second cooling/heating fluid 139 is fed from the first transition zone 125 to a cooling device 141 (radiator, cooling fan), where the cooling device 141 absorbs thermal energy from the cooling fluid and returns a third cooling/heating fluid 145 back to the heat exchanger 105, and where the cooling/heating fluid is configured to absorb heat from the flue gas, thereby creating a first temperature loop 143.

The CO₂ adsorption material may be transferred from the second end 133 to the carbon desorption zone 127 via a first CO₂ adsorption material transfer channel 135, where the CO₂ adsorption material is at a second temperature of between 120-150° C. In the carbon desorption zone 127, the carbon-rich CO₂ adsorption material may release the adsorbed CO₂ from the flue gas, where the released (desorbed) CO₂ may be communicated from the carbon desorption zone 127 to a first pump 147, where the first pump 147 may communicate CO₂ to a storage tank 149. The storage tank may hold compressed CO₂, or may be an adsorbent quick-connect, low-pressure storage tank. To make the system more efficient, the present disclosure aims at minimizing the storage pressure of the CO₂ tanks by using sorbent materials like MOFs that are specially tailored for this purpose. Reducing the storage pressure would considerably reduce the pumping requirements for the storage tank and increase safety associated with these tanks while retaining storage capacity.

When the carbon-rich CO₂ adsorption material has been desorbed sufficiently in the carbon desorption zone 127, the CO₂ adsorption material may be transported back to the carbon adsorption zone 115 via the second transition zone 129, where the CO₂ adsorption material enters via a first end 151 of the second transition zone 129 and exits the second transition zone via a second end 153 of the second transition zone 129. However, in the second transition zone 129 the CO₂ adsorption material is cooled from a second temperature of 120-150° C. in the first end 151 of the second transition zone to a first temperature of between 25-40° C. in a second end 153 of the second transition zone 129, where the first temperature is suited for carbon adsorption in the carbon adsorption zone 115. The thermal energy utilized to cool down the CO₂ adsorption material from its second temperature to the first temperature may be harvested from the cooling device 141, via e.g. a fourth cooling/heating fluid 155. When the thermal energy has been absorbed by the cooling fluid in the second transition zone 129, a fifth cooling/heating fluid 157 is fed from the second transition zone 129 to the cooling device 141 (radiator, cooling fan), where the cooling device 141 absorbs thermal energy from the cooling fluid, thereby creating a second temperature loop 159.

The CO₂ adsorption material may be transferred from the second end 153 of the second transition zone 129 to the carbon adsorption zone 115 via a second CO₂ adsorption material transfer channel 161, where the CO₂ adsorption material is at a first temperature of between 25-40° C.

The first transition zone 125 and the second transition zone 129 may be provided with a first actuator device 163 and a second actuator device 165, where the actuator devices 163, 165 may be configured to transport the CO₂ adsorption material from the first ends 131, 151 of the transition zones 125, 129 and towards the second ends 133, 153 of the transition zones 125, 129, where the actuators may mechanically move the CO₂ adsorption material from the carbon adsorption zone 115 to the carbon desorption zone 127, and from the carbon desorption zone 127 to the carbon adsorption zone 115, and maintain a cyclical flow of CO₂ adsorption material in the closed loop 123 of CO₂ adsorption material.

FIG. 3 shows a simple schematic diagram of a possible embodiment of a carbon capture system 201 in accordance with the present disclosure, where the carbon capture system 201 may include some or all elements of the devices shown in FIG. 1 and/or FIG. 2. The simplistic view of the carbon capture system 201 may comprise a carbon adsorption zone 203 and a carbon desorption zone 205 which are in the form of tubular members that may be positioned in a vertical position. The carbon adsorption zone may be in communication with a first fluid input 207, where flue gas may be fed into the carbon adsorption zone 203, and a first fluid output 209, where the flue gas may exit the carbon adsorption zone 203. The carbon desorption zone may comprise a CO₂ outlet 208 which is configured to release desorbed CO₂ from the carbon desorption zone 205. The carbon adsorption zone 203 may comprise a first CO₂ sorbent material 211, while the carbon desorption zone 205 may comprise a second CO₂ sorbent material 213. The carbon adsorption zone 203 may have a first CO₂ sorbent material input 215 and a first CO₂ sorbent material output 216, while the carbon desorption zone 205 may have a second CO₂ sorbent material input 217 and a second CO₂ sorbent material output 218, where the inputs are positioned close to bottom ends 219, 221 of the carbon adsorption zone 203 and the carbon desorption zone 205, while the outputs are positioned close to top ends 223, 225 of the carbon adsorption zone 203 and the carbon desorption zone 205.

The carbon capture device 201 may further comprise a first transition zone 227 and a second transition zone 229, where the transition zones 227, 229 comprise an actuation device 37 to transport CO₂ sorbent material from first ends 231, 233 of the first transition zone 227 and the second transition zone 229 to second ends 235, 237 of the first transition zone 227 and the second transition zone 229, in the direction of arrows A, B. The temperature of the CO₂ sorbent material may be increased and/or decreased in the transition zones 227, 229, as disclosed in relation to FIG. 1 and FIG. 2. The first ends 231, 233 may be connected to the first CO₂ sorbent material input 215 and the second CO₂ sorbent material output 218, and the second ends 235, 237 may be connected to the first CO₂ sorbent material input 215 and the second CO₂ sorbent material input 217, where the actuation device 37 of the transition zones 227, 229 are configured to elevate the CO₂ sorbent material in a vertical direction, so that when the CO₂ sorbent material enters the inputs 215, 217, gravity makes the CO₂ sorbent material mix in with the first CO₂ sorbent material 211 and the second CO₂ sorbent material 213. Thus, the system is capable of creating a cyclical route for the CO₂ sorbent material to be transferred continuously between the carbon adsorption zone 203 and the carbon desorption zone 205.

FIG. 4 shows a schematic view of the system seen in FIG. 2, where the system has been modified by providing a second cooling assembly 301 comprising an air compressor 303, a heat exchanger 305 and an expander 307. The second cooling assembly 301 has been added to the system shown in FIG. 2, where the purpose of the second cooling assembly 301 is to introduce a further stream of cool fluid to improve the efficiency of the adsorption process in the carbon capture system 101.

The second cooling assembly 301 comprises a fluid compressor, where the fluid compressor 303 may be an air compressor 303, and where ambient air is introduced into the air compressor 303 via an air intake 309. The air from the air intake 309 has an ambient temperature. The air compressor 303 may have one or more air cylinders 311, each having a piston 313 which is driven via an electric motor 315 to reciprocate with the air cylinder 311. The air cylinder 311 may have an air input valve 317 and an air output valve 319, where the air input valve 317 is open in order to draw air into the air cylinder 311, while being closed when air is being compressed inside the air cylinder 311. The air output valve 319 may be a one-way pressure-activated valve, allowing the compressed air to exit the air cylinder 311 at a predefined pressure.

As the compression of air increases the temperature of the air, the compressed air may be fed into a compressed air input 321 of a heat exchanger 305, where the heat exchanger 305 cools the compressed air back to an ambient temperature. The thermal energy transferred from the compressed air may be fed into the cooling device 141 via a fourth cooling/heating fluid communication conduit 325, where the thermal energy may be utilized in e.g. the desorption process of the carbon capture system. The heat exchanger 305 may be a water-based heat exchanger, where the heating/cooling fluid may be water.

The compressed air may exit the heat exchanger 305 at an ambient temperature via a compressed air output 327 and enter an expander 307 in which the compressed air is expanded to a predefined pressure, e.g. ambient pressure. The expansion of the compressed air reduces the temperature of the expanded air to a predefined temperature that may be controlled by the level of expansion of the compressed air. The predefined temperature may e.g. be around −45° C., which may be a significant reduction compared to the ambient temperature. The expanded air may be provided as a first cooling stream 331 towards the second end 153 of the second transition zone 129 and/or as a first cooling stream 331 towards the carbon adsorption zone 115 in order to transfer negative thermal energy to the adsorption material in the carbon adsorption zone 115 and/or to cool the adsorption material in the second end 153 of the second transition zone 129. Alternatively, or additionally, the first cooling stream 331 may be utilized to transfer negative thermal energy to the cold flue gas 111 to reduce the temperature of the flue gas before or simultaneously with its entry into the carbon adsorption zone 115.

The negative thermal energy provided by the first cooling stream 331 increases the adsorption capabilities and/or effectiveness of the adsorption material present in the carbon adsorption zone 115 and allows more CO₂ to be adsorbed from the cold flue gas 111. Thus, the negative thermal energy may be utilized to increase the adsorption efficiency of the adsorption material in the carbon capture system 101 shown in FIG. 2.

The term “negative thermal energy” is to be understood as a transferred heat which causes the flue gas 111 and/or the adsorption material to drop in temperature by the introduction of the first cooling stream 331.

Alternatively, the second cooling assembly 301 may provide a first cooling stream 331 that may be provided via vortex tubes, heat pumps or Stirling pumps, or any type of device that may provide a second cooling stream that is at a lower temperature than the ambient temperature of the carbon capture device 1. More preferably, the temperature may be at a temperature that is below zero degrees Celsius.

FIG. 5 shows a perspective view of a vehicle 351, e.g. a long-haul vehicle or a trailer truck, where the vehicle 351 comprises a cab 353. The carbon capture system 101 may be arranged at a back wall 355 of the cab 353 and may have direct access to the exhaust system 357 of the vehicle 351. A more detailed view of the carbon capture system 101 may be seen in FIG. 6, where the reference numbers shown for components or parts in FIG. 2 will be the same in FIG. 6.

The carbon capture system 101 may comprise a heat exchanger 105 having an exchanger input 107 and an exchanger output 109, where the exchanger input 107 is in fluid communication with the first fluid input 113 of the carbon adsorption zone 115. The exhaust system 357 of the vehicle 351 may be connected to the exchanger input 107 in order to feed the exhaust gasses (hot flue gas) towards the adsorption zone 115 in order for the CO₂ of the exhaust gas to be adsorbed by the adsorption material of the carbon capture system 101. The system 101 further comprises a first transition zone 125 where the adsorbent material may be heated up, a carbon desorption zone 127 where the adsorbent material releases the CO₂ and a second transition zone 129 where the adsorption material may be cooled down. The carbon capture system 101 may further comprise one or more storage tanks 149, and in this embodiment the system 101 has three CO₂ storage tanks 149 which are in fluid communication with the carbon desorption zone 127.

In this embodiment, an adsorption vessel 359 may define the adsorption zone 115, a first transition vessel 363 may define a first transition zone 125, a desorption vessel 365 may define the desorption zone 127 and a second transition vessel 367 may define the second transition zone 129. The vessels 359, 363, 365, 367 may be stacked on a base or a frame 361, with circular fluid communication between the zones 115, 125, 127, 129 as shown in FIG. 2 in order to allow the recirculation of the adsorbent material, using one or more actuator devices 163, 165. The structure of the vessels 359, 363, 365, 367 may be in the form of the vessels shown in the following FIG. 7 and FIG. 8.

FIG. 7 shows one embodiment of a vessel 359, 363, 365, 367, where each vessel may be substantially identical in the carbon capture system 101 shown in FIG. 6.

FIG. 7 shows a perspective view of one vessel 359, where the vessel has a top part 369 and a bottom part 371, and a cylindrical body 373. The top part 369 and/or the bottom part 371 may have a fluid communication input or output, allowing fluid communication of the absorbent material in and out of each vessel and into a vessel that is adjacent to the recirculation process of the carbon capture system 101. The input or output of the top part 369 and the bottom part 371 is not shown, but may be in any suitable shape or form allowing the adsorbent material to enter or exit the vessel 359.

FIG. 8 shows an exploded view of the cylindrical body 373, where a screw conveyor 375 may be positioned inside the volume 377 of the cylindrical body, and where a rotational movement of the screw conveyor 375 relative to the cylindrical body 373 may convey the adsorbent material from a bottom part 371 of the cylindrical body 373 to the top part 369 of the cylindrical body, or vice versa when the rotational movement of the screw conveyor 375 is in the opposite direction. The screw conveyor 375 may be in the form of a rotating helical screw blade which has a rotational axis that extends in parallel to a drive shaft 379 allowing the screw blade to be rotated around its rotating axis inside the cylindrical body 373. The top part 369 and/or the bottom part 371 of the vessel 359 may comprise a drive shaft opening 381 allowing a second drive shaft or an electric motor to be mechanically connected to the drive shaft 379 to provide rotational force to the screw conveyor 375.

The vessel shown in FIG. 7 and FIG. 8 may be used to define the first transition zone 125 and/or the second transition zone 129, as seen in FIG. 6, or may be utilized to define all the zones in the carbon capture system 101, where all the zones are provided with actuating devices to maneuver the adsorbent material from one zone to another zone in a recirculation process.

FIGS. 9A-9C are schematic diagrams of a carbon capture system 101 similar to that shown in FIGS. 5 and 6, where a secondary heating assembly 401 is in fluid communication with the carbon desorption zone 127 via a first heating inlet 403 and a first heating outlet 405. The secondary heating assembly 401 may be adapted to provide a secondary heating source for the carbon desorption zone 127 in order to increase the heating rate of the absorption material inside the desorption zone 127. By increasing the heating rate of the adsorption material, it may be possible to increase the CO₂ release from adsorption material in the desorption zone 127, which in turn allows the adsorption material to adsorb more CO₂ in the adsorption zone 115.

In FIGS. 9A-9C, this embodiment of the adsorption vessel 359 comprises a screw conveyor 375, and the second transition vessel 367 comprises a separate screw conveyor 375, where the two screw conveyors 375 are mechanically coupled to each other via a drive shaft 379, where a mechanical rotational force may be applied to the drive shaft 379 via the drive shaft opening 381 in/at the top of the second transition vessel 367 and the bottom of the adsorption vessel 359.

Similarly, the desorption vessel 365 and the first transition vessel 363 each comprises a screw conveyor 375, where a common drive shaft 379 connects the two screw conveyors 375, and a mechanical force may be applied from the outside of the vessels 363, 365.

Turning to FIG. 9A, the secondary heating assembly 401 comprises a heating vessel 411 having a screw conveyor 407, which is connected to a drive shaft 409, where the drive shaft is configured to rotate the screw conveyor 407. The drive shaft 409 and/or the screw conveyor 407 may be connected to a heat source having a heat source input 413 and a heat source output 415, where the heat source may be configured to provide heat energy to the drive shaft 409 and/or the screw conveyor 407. The heating vessel 411 may be filled with metal balls (not shown) made of a material having a high heat transfer coefficient so that the heat of the drive shaft 409 and/or the screw conveyor 407 may be transferred to the metal balls.

When the metal balls have absorbed the thermal energy of the screw conveyor 407 and/or the drive shaft 409, the screw conveyor 407 may force the metal balls into the desorption vessel 365 via the first heating outlet 405 in the direction of an arrow 421 so that the metal balls mix with the adsorption material in the desorption process. The facts that the metal balls have an outer surface and the adsorption material comes into contact with the outer surface mean that the thermal energy of the metal balls is transferred to the adsorption material and heats up the adsorption material in the desorption vessel 365. This secondary heating assembly 401 is in addition to the heating source shown in FIGS. 1 and 2.

When the metal balls have been moved inside the desorption vessel 365 in a direction towards the first heating inlet 403 and towards an upper part of the desorption vessel 365, the metal balls may be extracted from the adsorption material using a magnet 417 which is capable of separating the metal balls from the adsorption material and reintroducing the metal balls into the heating vessel 411 via the first heating inlet 403 in the direction of an arrow 423.

Within the understanding of the present disclosure, the metal balls may be made of a steel alloy, an iron alloy, a nickel alloy, or any alloy that may have a high heat conductivity and may have magnetic properties. Furthermore, the metal balls may have any suitable shape, such as a spherical, an elliptical or a circular shape.

FIG. 9B is a schematic view of a similar system to that shown in FIG. 9A, where the thermal energy transfer to the metal balls has been modified. The remaining parts of the carbon capture system 101 are identical, and the secondary heating assemblies 401 are identical, with the exception that the heat source input 413 and the heat source output 415 have been replaced with an inductive coil 425, where the inductive coil 425 may be positioned adjacent to the heating vessel 411, or may be positioned inside the heating vessel 411. The inductive coil 425 may be configured to heat up the metal balls by means of inductive energy using a magnetic field, and to convert magnetic energy into thermal energy in the metal balls. The transport process of the metal balls into the desorption vessel 365 may be identical to that shown in FIG. 9A.

FIG. 9C shows an alternative embodiment of a secondary heating assembly 427, where the source of the secondary heat may be in the form of steam. The heating vessel 411 may comprise a steam generator 429 having a steam fluid input 431 and a steam fluid output 433. Steam, which may be water in its gas phase, may exit the steam fluid output 433, where pressure in a downstream part 435 of the heating vessel 411 pushes the steam into the first heating outlet 405 in the direction of the arrow 421 and into the desorption vessel 365. The thermal energy of the steam may be transferred into the adsorbent material and increase the heat of the adsorbent material to accelerate the release of the CO₂ from the adsorbent material inside the desorption vessel 365.

The steam travels in a direction towards the first heating inlet 403 inside the desorption vessel 365 and may be passed into the heating vessel 411 via the first heating inlet 403 in the direction of the arrow 423 into an upstream part 437 of the heating vessel 411. Prior to entering the heating vessel 411, the steam may pass through a condenser 439 to transform the steam or any remaining part of the steam into water, where the water may be reintroduced into the steam generator 429 via the steam fluid input 431. The water, in its liquid and gas phase, may thereby be recirculated from the heating vessel 411 to the desorption vessel 365. Optionally, a circulation pump may be utilized to add further pressure to the recirculation.

The use of the terms “first”, “second”, “third” and “fourth”, “primary”, “secondary”, “tertiary”, etc., does not imply any particular order, but are included to identify individual elements. Moreover, the use of the terms “first”, “second”, “third” and “fourth”, “primary”, “secondary”, “tertiary”, etc., does not denote any order or importance, but rather the terms “first”, “second”, “third” and “fourth”, “primary”, “secondary”, “tertiary”, etc., are used to distinguish one element from another. Note that the words “first”, “second”, “third” and “fourth”, “primary”, “secondary”, “tertiary”, etc., are used here and elsewhere for labelling purposes only and are not intended to denote any specific spatial or temporal ordering.

Furthermore, the labelling of a first element does not imply the presence of a second element and vice versa.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims.

Although features have been shown and described, it will be understood that they are not intended to limit the claimed invention, and it will be made obvious to those skilled in the art that various changes and modifications may be made without departing from the spirit and scope of the claimed invention. The specification and drawings are, accordingly, to be regarded in an illustrative rather than a restrictive sense. The claimed invention is intended to cover all alternatives, modifications, and equivalents.

List of references

| | |
|---|---|
| 1 | Carbon capture system/device |
| 3 | Internal combustion engine |
| 5 | Fluid communication |
| 7 | Heat exchanger |
| 9 | Flue gas communication channel |
| 11 | Cooled flue gas |
| 13 | Carbon adsorption zone |
| 15 | First outlet |
| 17 | Carbon desorption zone |
| 19 | Actuator |
| 20 | Direction |
| 21 | Thermal energy |
| 23 | Direction |
| 25 | Carbon desorption zone |
| 27 | CO2 Feed |
| 29 | Pump |
| 31 | Fluid connection |
| 33 | Storage tank |
| 35 | Direction |
| 37 | Actuation device |
| 39 | Cooling |
| 41 | Cooling device |
| 43 | Direction |
| 101 | Carbon capture system |
| 103 | Flue gas input |
| 104 | Hot flue gas |
| 105 | Heat exchanger |
| 107 | Exchanger input |
| 109 | Exchanger output |
| 111 | Cold flue gas |
| 113 | First fluid input |
| 115 | Carbon adsorption zone |
| 117 | Carbon lean flue gas |
| 119 | First fluid outlet |
| 121 | Flue gas communication channel |
| 123 | Closed CO2 sorbent material loop |
| 125 | First transition zone |
| 127 | Carbon desorption zone |
| 129 | Second transition zone |
| 131 | First end of first transition zone |
| 133 | Second end of first transition zone |
| 135 | First CO2 adsorption material transfer channel |
| 137 | First cooling/heating fluid |
| 139 | Second cooling/heating fluid |
| 141 | Cooling device |
| 143 | First temperature loop |
| 145 | Third cooling/heating fluid |
| 147 | First pump |
| 149 | Storage tank |
| 151 | First end of the second transition zone |
| 153 | Second end of the second transition zone |
| 155 | Fourth cooling/heating fluid |
| 157 | Fifth cooling/heating fluid |
| 159 | Second temperature loop |
| 161 | Second CO2 adsorption material transfer channel |
| 163 | First actuator device |
| 165 | Second actuator device |
| 201 | Carbon capture system |
| 203 | Carbon adsorption zone |
| 205 | Carbon desorption zone |
| 207 | First fluid input |
| 208 | First carbon outlet |
| 209 | First fluid output |
| 211 | First CO2 sorbent material |
| 213 | Second CO2 sorbent material |
| 215 | First CO2 sorbent material input |
| 216 | First CO2 sorbent material output |
| 217 | Second CO2 sorbent material input |
| 218 | Second CO2 sorbent material output |
| 219 | Bottom end of carbon adsorption zone |
| 221 | Bottom end of carbon desorption zone |
| 223 | Top end of carbon adsorption zone |
| 225 | Top end of carbon desorption zone |
| 227 | First transition zone |
| 229 | Second transition zone |
| 231 | First end of the first transition zone |
| 233 | First end of the second transition zone |
| 235 | Second end of the first transition zone |
| 237 | Second end of the second transition zone |
| 301 | Second cooling assembly |
| 303 | Air compressor |
| 305 | Heat exchanger |
| 307 | Expander |
| 309 | Air intake |
| 311 | Air cylinder |
| 313 | Piston |
| 315 | Electric motor |
| 317 | Air input valve |
| 319 | Air output valve |
| 321 | Air input of heat exchanger |
| 325 | Fourth cooling/heating fluid communication conduit |
| 327 | Compressed air output |
| 331 | First cooling stream |
| 351 | Vehicle |
| 353 | Cab |
| 357 | Exhaust system |
| 359 | Adsorption vessel |
| 361 | Frame |
| 363 | First transition vessel |
| 365 | Desorption vessel |
| 367 | Second transition vessel |
| 369 | Top part of vessel |
| 371 | Bottom part of vessel |
| 373 | Cylindrical body |
| 375 | Screw conveyor |
| 377 | Volume of cylindrical body |
| 379 | Drive shaft |
| 381 | Drive shaft opening |
| 401 | Secondary heating assembly |
| 403 | First heating inlet |
| 405 | First heating outlet |
| 407 | Screw conveyor |
| 409 | Drive shaft |
| 411 | Heating vessel |
| 413 | Heat source input |
| 415 | Heat source output |
| 417 | Magnet |
| 421 | Arrow |
| 423 | Arrow |
| 425 | Inductive coil |
| 427 | Secondary heating assembly |
| 429 | Steam generator |
| 431 | Steam fluid input |
| 433 | Steam fluid output |
| 435 | Downstream part of heating vessel |
| 437 | Upstream part of heating vessel |
| 439 | Condenser |
| A | Arrow |
| B | Arrow |

1. A carbon capture device, comprising:
a flue gas input,
a flue gas output,
a carbon adsorption zone that is in fluid communication with the flue gas input and in fluid communication with the flue gas output, where a first flue gas communication channel comprises the carbon adsorption zone, where the first flue gas communication channel comprises a first fluid input and a first fluid output, and the carbon adsorption zone comprises a first CO₂ sorbent material positioned downstream from the first fluid input and upstream to/of the first fluid output, where the first fluid input is in fluid communication with the flue gas input, and where the flue gas is directed past the CO₂ sorbent material and towards the first fluid output, where the first fluid output is in fluid communication with the flue gas output,
a carbon desorption zone, where the carbon desorption zone comprises a second CO₂ sorbent material, and
an actuation device, where the actuation device is configured to transport carbon-rich first CO₂ sorbent material from the carbon adsorption zone to the carbon desorption zone and to transport carbon-lean second CO₂ sorbent material from the carbon desorption zone to the carbon adsorption zone.

2. A carbon capture device in accordance with claim 1, wherein the device comprises a heat exchanger that is configured to extract heat energy from the flue gas upstream from the flue gas input, and optionally provide thermal energy to the CO₂ sorbent material to increase or decrease the temperature of the CO₂ sorbent material inside the system.

3. A carbon capture device in accordance with claim 1, wherein the actuation device may be in the form of a screw (auger) conveyor device or a belt conveyor having transport pockets.

4. A carbon capture device in accordance with claim 1, wherein the carbon capture device comprises a closed loop system, where the carbon adsorption zone is in communication with the carbon desorption zone and/or where the carbon desorption zone is in communication with the carbon adsorption zone.

5. A carbon capture device in accordance with claim 1, wherein the carbon capture device comprises a closed circulating structure configured to receive the carbon adsorption material, and where the closed circulating structure comprises the carbon adsorption zone, the carbon desorption zone and/or the actuation device.

6. A carbon capture device in accordance with claim 1, wherein the carbon capture device comprises a heat exchanger configured to transfer thermal energy from the flue gas to a first cooling fluid.

7. A carbon capture device in accordance with claim 1, wherein the first and/or the second CO₂ sorbent material is heated from a first temperature to a second temperature in a first transition zone between the carbon adsorption zone and the carbon desorption zone.

8. A carbon capture device in accordance with claim 1, wherein the first and/or the second CO₂ sorbent material is cooled from a second temperature to a first temperature in a second transition zone between the carbon desorption zone and the carbon adsorption zone.

9. A carbon capture device in accordance with claim 1, wherein the carbon adsorption zone is arranged in a first tubular body, and the carbon desorption zone is arranged in a second tubular body.

10. A carbon capture device in accordance with claim 1, wherein the carbon adsorption zone and/or the carbon desorption zone is in the form of a constantly moving fluidized bed.

11. A carbon capture device in accordance with claim 1, wherein the carbon capture device may comprise a second cooling assembly, where the second cooling assembly provides a stream of cooling fluid to the adsorbent material and/or the carbon adsorption zone at a second temperature that is lower than the ambient temperature of the carbon capture system.

12. A carbon capture device in accordance with claim 11, wherein the second temperature is below 0° C., more specifically between 0° C. and −80° C., even more specifically between −10° C. and −60° C., or even more specifically between −40° C. and −50° C.

13. A carbon capture device in accordance with claim 1, wherein the carbon capture device is a carbon capture device for an internal combustion engine (3).

14. A carbon capture device in accordance with claim 1, wherein the first CO₂ sorbent material and/or the second CO₂ sorbent material is in the form of pellets, powder, a granular substance, a grainy substance, extruded forms, fibres or particulates.

15. A carbon capture system for flue gas, the system comprising:
an internal combustion engine of a vehicle, and
a carbon capture device in accordance with claim 1.
